(19) United States
(12) Patent Application Publication
(10) Pub. No.: US 2006/0200988 A1
(43) Pub. Date: Sep. 14, 2006

(54) Sandwich orifice disc

(75) Inventors: Christoph Hamann, Thalmassing (DE); Michael Kelley, Newport News, VA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/373,656

(22) Filed: Mar. 10, 2006

Related U.S. Application Data
(60) Provisional application No. 60/660,911, filed on Mar. 11, 2005.

(51) Int. Cl. B23P 15/16; B05B 1/26; F02M 61/00

(52) U.S. Cl. 29/890.143; 239/533.12; 239/504; 29/890.142; 29/527.2

(57) ABSTRACT

An example fuel injector orifice plate assembly includes a plastic plate within which is an orifice for metering and directing fuel flow in a desired spray pattern, and a metal support plate for supporting and maintaining the stability of the desired spray pattern generated by the orifices within the plastic plate. The orifice plate includes orifices sized to provide a desired spray pattern of fuel. The metal support plate is more rigid than the orifice plate and provides the desired strength and rigidity for withstanding the cyclical pressure fluctuations caused by operation of the fuel injector.

### CROSS REFERENCE TO RELATED APPLICATION

The application claims priority to U.S. Provisional Application No. 60/660,911 which was filed on Mar. 11, 2005.

### BACKGROUND OF THE INVENTION

This invention generally relates to an orifice disc for a fuel injector. More particularly, this invention relates to a method of fabricating an orifice disk for atomizing and directing fuel flow from a fuel injector.

A fuel injector for an automobile meters fuel providing a desired fuel to air ratio for combustion. The fuel injector typically injects a desired quantity of fuel into an air stream that is subsequently drawn into the combustion chamber. Atomization of fuel improves the combustion process resulting in a reduction of undesirable emissions Conventional atomization is performed by spraying streams of fuel into an air stream. The smaller the stream of fuel, the better the atomization.

Current fuel injectors include a metal orifice plate with one or many openings. The holes are typically formed by a punching process that places a practical limit on the size of the orifices. Metal is utilized to withstand the exposure to the fuel, and to provide the strength required to endure the temperatures and pressure encountered during operation. Because the fuel injector operates in a cyclical on/off manner, the metal orifice plate is subjected to a cyclical pounding caused by the sharp increases in pressure produced by fuel being pumped into the combustion chamber.

Disadvantageously, emission standards are increasingly strict and require an ever decreasing quantity of emissions. One method of reducing emissions is to improve combustion by improving fuel atomization. However, increased fuel atomization is best implemented by decreasing orifice sizes, potentially beyond the reasonable capabilities of current metal punching process. Further, the metals utilized for current orifice plates are not economically compatible with advanced process that is capable of providing the desired smaller openings.

Accordingly, it is desirable to develop and design an orifice plate and method of constructing an orifice plate that provides the desired smaller openings while maintaining the required strength and durability to operate in the harsh engine environment.

### SUMMARY OF THE INVENTION

An example fuel injector orifice plate assembly includes a plastic plate within which is an orifice for metering and directing fuel flow in a desired spray pattern, and a metal support plate for supporting and maintaining the stability of the desired spray pattern generated by the orifices within the plastic plate.

The example fuel injector includes the orifice plate assembly that provides for the atomization of fuel that is combined and mixed with air and eventually drawn into the combustion chamber. The plastic orifice plate includes orifices sized to provide the desired spray pattern of fuel. The size of the orifices provides the desired increased atomization of fuel that improves the combustion process.

The metal support plate includes openings that correspond to the position of the orifices. The metal support plate is significantly more rigid than the plastic orifice plate and provides the desired strength and rigidity for withstanding the cyclical pressure fluctuations caused by operation of the fuel injector. The openings in the metal plate are larger than the corresponding orifice such that the openings do not interfere with fuel flow through the orifices.

The plastic orifice plate provides for use of optimal process in the formation of the orifices. Smaller orifice diameters provide smaller individual fuel streams through the orifice plate that in turn improves fuel atomization. The improved atomization provides the desired improvements in combustion.

Accordingly, an example orifice plate assembly according to this invention provides the desired smaller openings while maintaining the required strength and durability to operate in the harsh engine environment.

These and other features of the present invention can be best understood from the following specification and drawings, the following of which is a brief description.

### BRIEF DESCRIPTION OF THE DRAWINGS

FIG. 1 is a schematic view of an example fuel injector according to this invention.

FIG. 2 is a cross-sectional view of the example fuel injector including the example orifice plate assembly according to this invention.

FIG. 3 is a cross-sectional view of the example orifice plate assembly according to this invention.

FIG. 4 is cross-sectional view of another example orifice plate assembly according to this invention.

FIG. 5 is a cross-sectional view of another example orifice plate assembly according to this invention.

FIG. 6 is a schematic representation of an example method of constructing an orifice plate assembly according to this invention.

FIG. 7 is a schematic representation of another example method of constructing an orifice plate assembly according to this invention.

### DETAILED DESCRIPTION OF THE PREFERRED EMBODIMENT

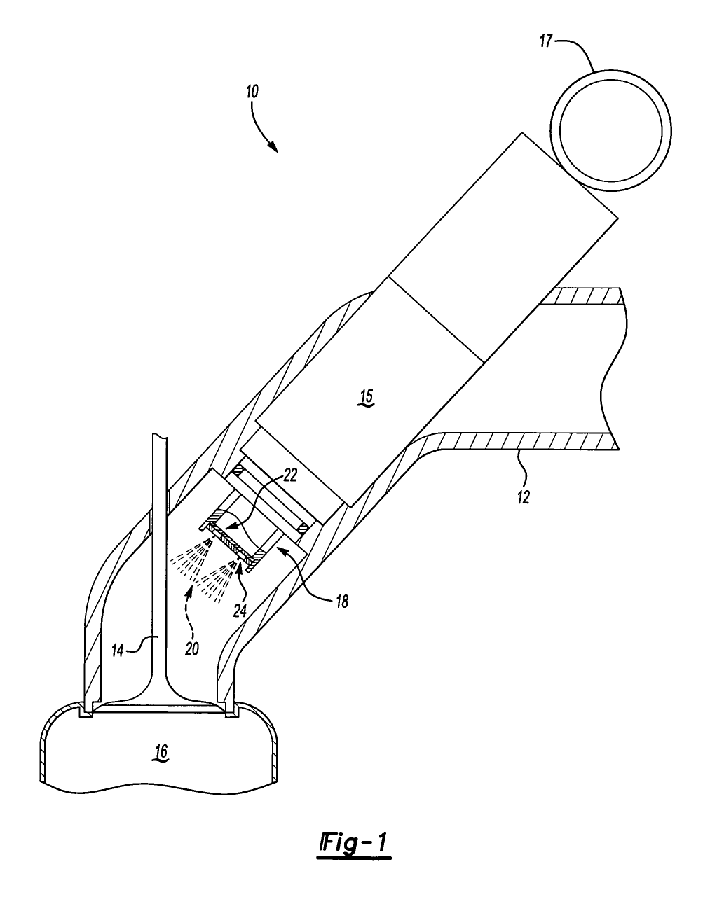

Referring to FIG. 1, an intake assembly 10 for a motor vehicle is schematically shown and includes a fuel injector 15 supported by an intake manifold 12. The intake manifold communicates an air fuel mixture through a valve 14 to a combustion chamber 16. The fuel injector 15 includes an orifice plate assembly 18 that provides for the atomization of fuel 20 that is combined and mixed with air and eventually drawn into the combustion chamber 16. The example air intake assembly 10 is shown and described as an example and a worker skilled in the art would understand that other intake assemblies and fuel injectors will benefit from the disclosure of this invention.

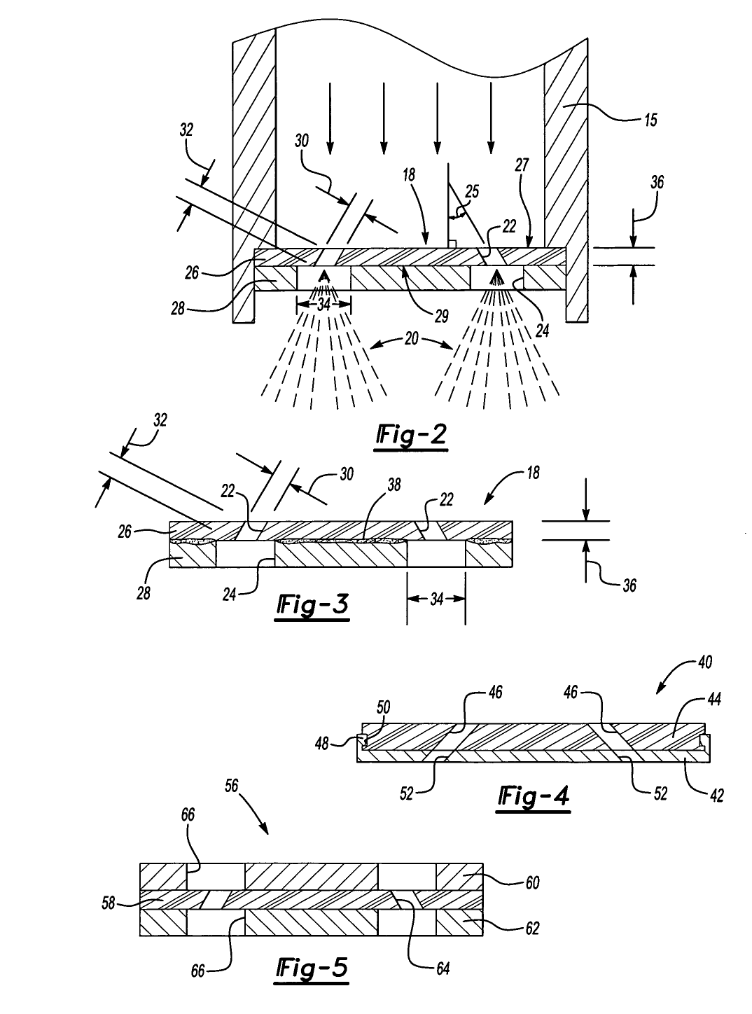

Referring to FIG. 2, the orifice plate assembly 18 includes a plastic orifice plate 26 supported by a metal support plate 28. The orifice plate 26 includes orifices 22 sized to provide a desired spray pattern of fuel 20. The size of the orifices 22 provides the desired atomization of fuel that is mixed with air. In the example orifice plate assembly 18, each of the orifices 22 includes a diameter 30 and a length 32. The length 32 is largely determined by a thickness 36 of the orifice plate 26. Also, the orifices 22 are disposed at an angle 25 relative to a line normal to the fuel inlet surface 27 of the orifice plate 26. In this example the length 32 is greater than the thickness 36 due to the angle 25 of the orifices 22. The example orifices 22 are configured to provide a ratio of the length 32 to the diameter 30 of substantially one. Accordingly, the desired ratio for the orifices 22 provides that the orifice diameter 30 is substantially equal to the length 32.

The orifice plate 26 is constructed of a plastic material that is compatible with the environment in which the fuel injector 15 operates. The example plastic material is a polyimide plastic. Other plastic materials as are known in the art that are compatible with the fuel, temperatures and pressures encountered during operation of the fuel injector 15 and are also within the contemplation of this invention.

The metal support plate 28 includes openings 24 that correspond to the position of the orifices 22. The metal support plate 28 is disposed on a fuel outlet surface 29 of the orifice plate 26. The metal support plate 28 is significantly more rigid than the orifice plate 26 and provides the desired strength and rigidity for withstanding the cyclical pressure fluctuations caused by operation of the fuel injector.

The openings 24 are larger than the corresponding orifice 22 such that the openings 24 do not interfere with fuel flow through the orifices 22. Further, the openings 24 are of such a size compared to the orifices 22 to prevent any ancillary effects on fuel flow while still providing the desired support of the plastic orifice plate 26 and prevent undesired deflection.

The orifice plate assembly 18 is attached and supported to an end of the fuel injector 15 such that fuel flow is forced and directed through the orifices 22. The diameter of the orifices 22 are determined to provide significant atomization to the fuel. Although two orifices 22 are illustrated, a plurality of orifices 22 may be formed within the plastic orifice plate 26 to produce the desired spray pattern of fuel. The metal support plate 28 prevents deflection of the plastic orifice plate 26 to maintain the desired stable fuel spray pattern.

Referring to FIG. 3, the orifice plate assembly 18 is illustrated without the surrounding fuel injector 15 and includes the metal support plate 28 to prevent undesired deflections. The metal support plate 28 is attached to the orifice plate 26 by an adhesive 38. Although an adhesive 38 is shown, any method for attaching the plastic orifice plate 26 to the metal support plate 28 is within the contemplation of this invention. The orifice plate 26 is mated to the support plate 28 to provide the desired orifice size combined with the desired rigidity to maintain a desired fuel spray pattern.

Referring to FIG. 4, another example orifice assembly 40 is shown and includes a plastic orifice plate 44 attached mechanically to a metal support plate 42. The metal support plate 42 includes a tab 48 that fits within a slot 50 on an outer perimeter of the plastic orifice plate 44. The plastic orifice plate 44 includes orifices 46 that correspond to openings 52 within the metal support plate 42. The openings 52 are substantially the same size as the orifices 46 and provide metering functions that correspond with the orifices 46. The metal support plate 42 is provided with structural features that provide for the stability of the spray pattern produced through the orifices 46.

Referring to FIG. 5, another example orifice assembly 56 includes a first metal support plate 60 disposed on a fuel inlet side of a plastic orifice plate 58, and a second metal support plate 62 disposed on the fuel outlet side of the plastic orifice plate 58. Both the first metal support plate 60 and the second metal support plate 62 include openings 66 that correspond to orifices 64 formed within the plastic orifice plate 58. The orifices 58 provide the desired atomization and direction of fuel flow. The first and second metal support plates 60, 62 provide the desired support that prevents deflection and any resulting fuel spray pattern instability. The first and second metal plates 60, 62 therefore provide support without interfering with the fuel atomization provided by the much smaller orifices 64 formed in the plastic orifice plate 58.

The plastic orifice plate 58 provides for use of optimal process in the formation of the orifices 64. Smaller orifice diameters provide smaller individual fuel streams through the orifice plate assembly 56 that in turn improves fuel atomization. The improved atomization provides the desired improvements in combustion.

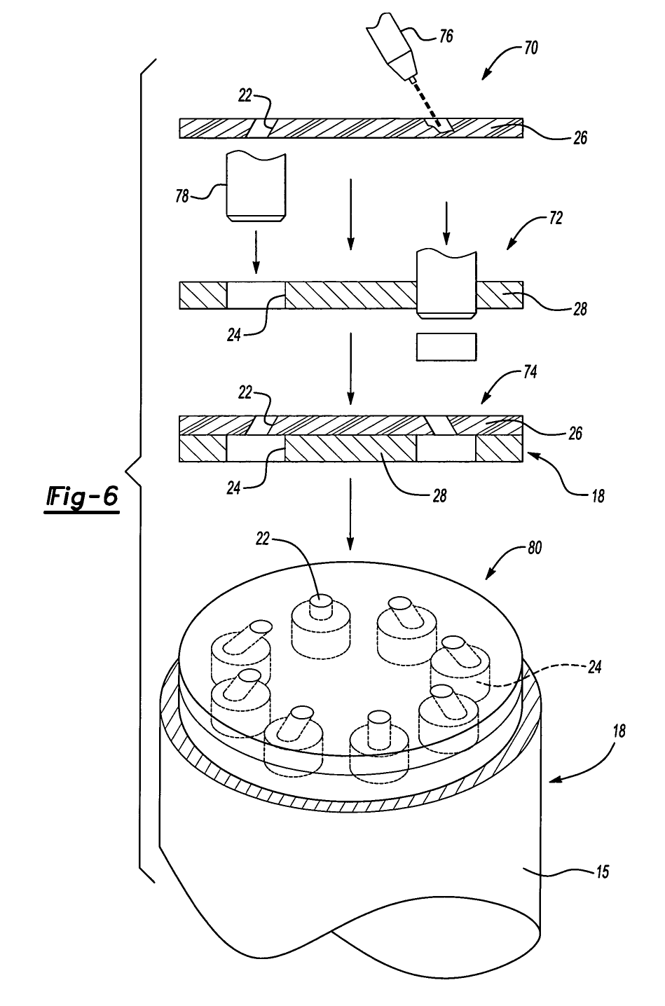

Referring to FIG. 6, an example method of fabricating and assembling the orifice plate assembly 18 is schematically shown and includes an initial step of fabricating orifices 22 within the orifice plate 26. The orifice plate 26 is fabricated from a plastic material that is compatible with the temperatures and pressures encountered within an engine intake manifold environment. Further, the plastic orifice plate 26 should also be compatible with gasoline and other fuels utilized in a combustion engine.

The example plastic orifice plate 26 is fabricated from a Polyimide plastic material. As appreciated, other plastic materials that are compatible with the environment in which the orifice plate 26 operates are also within the contemplation of this invention. The use of plastic material provides for the efficient utilization of a laser 76 to create orifices of the desired sizes. Use of a laser 76 in metal orifices discs is difficult and expensive. The use of the plastic material reduces the expense and provides for the practical fabrication of orifices of a size that meets the desired length to diameter ratio of one.

The fabrication process begins with the fabrication of the orifice plate 26 by laser drilling the orifices 22 at the desired diameter and angle to normal. Although, a laser process is illustrated in the example embodiment, other process, such as punching that also are easier and more efficiently performed in the plastic orifice plate 26 are within the contemplation of this invention.

Fabrication of the example metal support plate 28 utilizes punching operations to generate the openings 24. The openings 24 are much larger than the orifices 22 and therefore do not require the precision utilized in the creation of the orifices 22. Further, as the openings 24 are not utilized for fuel metering or spray pattern definition, more generous tolerances can be implemented to improve economic and assembly efficiencies.

Once the plastic orifice plate 26 and the metal support plate 28 are fabricated with the desired openings 24 and orifices 22, they are attached to each other as is generally indicated at 74. The means and method of attaching the plastic orifice plate 26 to the metal support plate 28 can vary depending on application specific requirements. The plastic orifice plate 26 can be bonded to the metal support plate 28, or be mechanically attached by way of a tab and slot configuration. Further, assembly of the orifice plate assembly 18 to the fuel injector 15 as is schematically indicated at 80 can utilize interference fits to hold the orifice plate 26 in place.

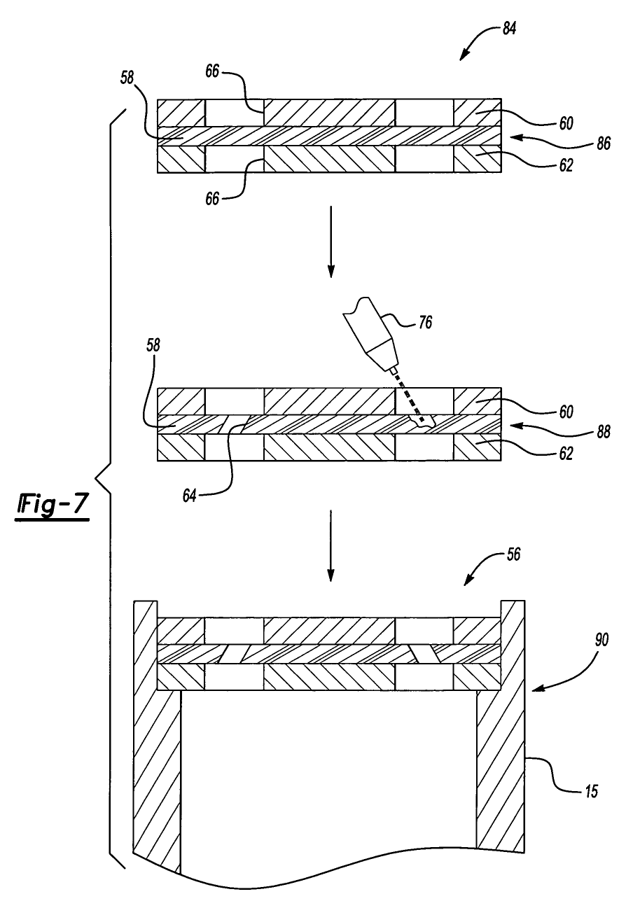

Referring to FIG. 7 another example method of assembly is schematically indicated at 84 and includes the formation of layered assembly with the plastic orifice plate 58 sandwiched between a first metal support plate 60 and a second metal support plate 62. The plastic orifice plate 58 can be molded onto the first and second metal support plates 60, 62 or can be applied utilizing known process. The first and second metal support plates 60, 62 include the punched out openings 66. However, the plastic orifice plate 58 does not include the orifices.

The orifices 64 are formed in the example method by a laser device 76 as is indicated at step 88. The laser device 76 forms orifices 64 of desired diameters and angles relative to normal. As appreciated, other processes capable of making the orifices 64 of the desired diameters and angles are also within the contemplation of this invention. Once the orifices 64 are formed the completed orifice plate assembly 56 is assembled to the fuel injector 15 as is indicated in the illustrated example at 90.

The plastic orifice plate provides for the use of processes not practical or economical for application to metal plates. Further, the example orifice assemblies provide for the efficient, practical fabrication and utilization of increasingly smaller orifices to improve fuel atomization and thereby combustion. The improved combustion can provide for increased performance and reduced emissions.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A fuel orifice disc assembly comprising:
a plastic disc including an orifice for communicating fuel with an air stream; and
a metal support for supporting the plastic disc and controlling deflection of the plastic disc, wherein the metal support includes an opening corresponding to the orifice within the plastic disc.

2. The assembly as recited in claim 1, wherein the opening is larger than the orifice.

3. The assembly as recited in claim 1, wherein the metal support is attached to a side opposite a fuel inlet side of the plastic disc.

4. The assembly as recited in claim 1, wherein the metal support comprises a first metal plate disposed on a fuel inlet side of the plastic disc, and a second metal plate disposed on a fuel outlet side of the plastic disc.

5. The assembly as recited in claim 4, wherein each of the first metal plate and the second metal plate include an opening corresponding to the orifice within the plastic disc.

6. The assembly as recited in claim 5, wherein the opening in each of the first metal plate and the second metal plate is larger than the orifice.

7. The assembly as recited in claim 1, wherein the orifice extends through the plastic disc at a desired angle.

8. The assembly as recited in claim 1, wherein the orifice comprises a plurality of orifices disposed within the plastic disc providing a desires spray pattern.

9. The assembly as recited in claim 1, wherein a length of the orifice is substantially equal to a width of the orifice.

10. The assembly as recited in claim 1, wherein the metal support substantially prevents deflection of the plastic disc responsive to cyclical fuel flow there through.

11. A fuel injector assembly comprising:
a valve assembly for controlling fuel flow; and
an orifice plate assembly comprising a plastic plate including an orifice sized to provide a desired fuel flow emission from the fuel injector and a metal support attached to the plastic plate that controls deflection of the orifice plate.

12. The fuel injector assembly as recited in claim 11, wherein the metal support comprises a first metal plate including an opening corresponding to the orifice within the plastic plate.

13. The fuel injector assembly as recited in claim 11, wherein the metal support comprises a first metal plate attached to the orifice plate on a fuel inlet side and a second metal plate attached to the orifice plate on a fuel outlet side.

14. The fuel injector assembly as recited in claim 11, wherein the first metal plate and the second metal plate include an opening that corresponds to the orifice in the orifice plate and the opening within each of the first metal plate and the second metal plate is larger than the orifice.

15. The fuel injector assembly as recited in claim 11, wherein the orifice plate includes a plurality of orifices defining a desired spray pattern.

16. The fuel injector assembly as recited in claim 11, wherein the orifice plate comprises a disc.

17. The fuel injector assembly as recited in claim 11, wherein a length of the orifice is substantially equal to a width of the orifice.

18. A method of fabricating an orifice plate for a fuel injector comprising the steps of:
a) forming an orifice plate from a plastic material;
b) forming at least one orifice within the plastic material, wherein the at least one orifice defines a fuel spray pattern;
c) forming an opening in a metal support; and
d) attaching the metal support to the orifice plate such that the orifice and the opening are aligned.

19. The method as recited in claim 18, wherein the opening in the metal support is larger than the orifice.

20. The method as recited in claim 18, wherein the attaching step comprises attaching the metal support to a fuel outlet side of the orifice plate.

21. The method as recited in claim 18, wherein the metal support comprises a first metal plate attached to a fuel inlet side of the orifice plate and a second metal plate attached to a fuel outlet side of the orifice plate.

22. The method as recited in claim 18, wherein the attaching step includes molding the orifice plate to the metal support.

23. The method as recited in claim 18, wherein the attaching step includes mechanically attaching the metal support to the orifice plate.

24. The method as recited in claim 18, wherein the step of forming the at least one orifice comprising laser drilling the orifice through the plastic orifice plate.

25. The method as recited in claim 18, wherein the step of forming the at least one orifice comprises punching the orifice through the plastic orifice plate.

26. The method as recited in claim 18, wherein the step of forming the at least one orifice comprises forming a plurality of orifices to define a desired spray pattern.

27. The method as recited in claim 18, wherein the step of forming the at least one orifice comprises forming an orifice with a length through the orifice substantially equal to a diameter of the orifice.

28. The method as recited in claim 18, wherein the step of forming the at least one orifice comprises forming the at least one orifice at an angle to provide a desired fuel spray pattern.
